(19) United States
(12) Patent Application Publication
(10) Pub. No.: US 2012/0101865 A1
(43) Pub. Date: Apr. 26, 2012

(54) System for Rating Agents and Customers for Use in Profile Compatibility Routing

(76) Inventor: Slava Zhakov, Burlingame, CA (US)

(21) Appl. No.: 12/910,179

(22) Filed: Oct. 22, 2010

(51) Int. Cl. G06Q 10/00

(52) U.S. Cl. 705/7.13; 705/7.42

(57) ABSTRACT

A method for routing transactions from customers to agents follows a process of receiving, at a routing server, a transaction to route, and soliciting the customers before connection to an agent, to rate the agents after agent interaction, and checking for existing customer routing profiles. Upon finding an existing routing profile for a customer, checking for existing routing profiles of available agents, and finding existing agent routing profiles, routing customer to agent by matching routing profiles. If no existing routing profile is found for a customer, routing to an agent by a default routing strategy.

### BACKGROUND OF THE INVENTION

1. Field of the Invention

The present invention is in the field of telephony services including call center services and pertains particularly to methods and apparatus for routing interactions based on matching of profiles of agents and customers.

2. Discussion of the State of the Art

In the art of telephony services, call centers exist for the purpose of handling sales and service requirements for companies that sell products and services to a base of customers generally referred to in the art as a customer base. In many fields of marketing, customers of certain businesses are repeat customers meaning that from time to time the same customer patronizes the same business and develops an ongoing relationship with that business entity. It is to this type of business to customer (B2C) relationship that the present invention addresses.

In traditional call center environments, it is important to meet certain goals that are often defined in service level agreements that call center service providers have with clients (businesses) they represent. In some cases performance goals or criteria are internally defined such as with a company that provides its own call center services. However, in all cases it is important that sales goals are met and that customers are well handled so repeat business from these customers is more likely.

In efforts to meet certain goals that might be detailed in a service level agreement or that may just be a stated goals of a call center operation, improving agent performance and creating a better customer experience for customers has been and still is an ongoing effort and subject to much research and development. Many improvements in overall call-center performance have to do with enhanced routing strategies that may range from skills-based and priority routing regimens to predictive agent-availability and success-probability or trend-based routing. In some routing systems known to the inventor customers are monitored for moods, certain actions, or behaviors that tend to boost the probability that those customers will buy or otherwise engage in the products or services offered.

Customer experience with a call center may be defined generally as the type of positive or perhaps negative experience that customer has had interacting with the call center agents or automated systems. The quality of a customer's experience may have some bearing on whether that customer will continue patronizing the business, or move to a competitor, for example. Therefore, any way to gauge the satisfaction level of the customer is seen as a possible tool to help the business learn how to improve quality and service and hopefully add to customer satisfaction and loyalty to the business. Often customers are asked to take customer surveys that provide the business with recorded knowledge (admission) of the customer's interaction experience with a business agent or system whether positive or negative. Answered customer surveys collectively form a basis for improvement that can be readily identified as a result of analysis of those records. Such improvements may involve changes to agent practices or system policies or procedures.

One challenge with surveying customers is that it may be a time consuming activity and that not all customers like to or are willing to take such surveys. Another problem is that often surveys are conducted well after the experience of the customer has occurred dampening the accuracy of the survey results. Monitoring agent interactions with customers can produce statistical information that can later be used to improve performance overall with a hope of also enhancing customer experience, but such efforts are most general and the data analyzing criteria is often too specific to a single goal and may not consider other aspects of an interaction that might be considered part of a customer's experience.

Therefore, what is clearly needed is a system for creating and maintaining customer and agent profile information such that specific aspects of customer and agent profiles might be matched during routing of interactions to promote compatibility between the agents and customers for future business.

### SUMMARY OF THE INVENTION

A problem stated above is that enhancing customer experience is desirable in a call-center environment, but traditional means of doing so such as through heavy agent involvement in training and additional efforts also create overhead and reduced numbers of calls handled in any given work period. The inventors therefore considered functional components of a call-center looking for elements that exhibit interoperability that could potentially be harnessed to provide a system that enhances the customer experience, but in a manner that would not create more overhead or cost in routing.

Every call center is propelled by incoming interactions, one by-product of which is an abundance of waiting in queue to be routed to a next available agent. Most such call centers employ routers and intelligent routing strategies to conduct routing from the call center access point to a live agent and intelligent routing strategies are typically part of such apparatus.

The present inventors realized in an intuitive moment that is, at the time of interaction with an agent, one or more psychological inferences could be made about the customer and agent in the transaction, significant enhancement of that customer's experience might result during future interaction between that customer and the business. Therefore, the inventors developed a unique routing system and method that allowed customers to be profiled in the background and subsequently routed to agents, at least in part, according to psychological compatibility. A better customer experience results with no impediment to call flow or agent overhead created.

Accordingly, in an embodiment of the present invention, a method for routing transactions from customers to agents is provided, comprising the steps of (a) upon receiving, at a routing server, a transaction to route, soliciting the customers before connection to an agent, to rate the agents after agent interaction, and checking for existing customer routing profiles; (b) upon finding an existing routing profile for a customer, checking for existing routing profiles of available agents, and finding existing agent routing profiles, routing customer to agent by matching routing profiles; (c) if no existing routing profile is found for a customer, routing to an agent by a default routing strategy; (d) tracking routing and agent interaction, and presenting to the customers, by software executing from a non-transitory medium, and after the interactions, an interactive rating interface; (e) rating the agents by the customers using the interactive interface; (f) updating agent profiles with rating results of customer ratings, and in the event of no available profile, creating a new profile for the agents with the rating results; and (g) discerning characteristics of rating customers by the ratings of agents by the customers, updating customer profiles with the characteristics, and in the event of no available customer profile, creating a new customer profile with the characteristics.

In one embodiment of the method, in step (e) the interactive interface is an audible presentation delivered to a customer by an interactive voice response unit. Also in one embodiment, in step (e) the interactive interface is a displayed interactive form. Also in one embodiment, in step (e) the interactive interface includes one or more interactive questions with preprogrammed selectable responses. Still in an embodiment, in step (e) the interactive interface includes one or more interactive graphics.

In some embodiments, in step (e) the interface includes a pre-assembled list of agent traits whereby the customer prioritizes two or more of the listed traits. Also in some embodiments agent and customer profiles further comprise data and characteristics derived from other than the rating process, including customer interaction history, and agent skills. In some embodiments there is a step for publishing agent profiles in human-readable form. Also in some embodiments customers are provided with incentives to rate an agent.

In another aspect of the invention a system for routing transactions from customers to agents is provided, comprising a routing server receiving transactions to route, a data repository storing routing profiles for customers and agents, and routing software executing on the routing server from a non-transitory machine readable medium, the routing software providing: a function soliciting customers before connection to an agent to rate the agents after agent interaction, a function checking for existing customer routing profile, and upon finding an existing routing profile for a customer, checking for existing routing profiles of available agents, and finding existing agent routing profiles, routing customer to agent by matching routing profiles, and finding no profile for the customer, routing to an agent by a default routing strategy, a function tracking routing and agent interaction, and presenting to the customers, by software executing from a non-transitory medium, and after the interactions, an interactive rating interface, a function rating the agents by the customers using the interactive interface, a function updating agent profiles with rating results of customer ratings, and in the event of no available profile, creating a new profile for the agents with the rating results, and a function discerning characteristics of rating customers by the ratings of agents by the customers, updating customer profiles with the characteristics, and in the event of no available customer profile, creating a new customer profile with the characteristics.

In one embodiment of claim 10 wherein the interactive interface is an audible presentation delivered to a customer by an interactive voice response unit. Also in an embodiment the interactive interface is a displayed interactive form. Also in an embodiment the interactive interface includes one or more interactive questions with preprogrammed selectable responses. Still in an embodiment the interactive interface includes one or more interactive graphics.

In some embodiment the interface includes a pre-assembled list of agent traits whereby the customer prioritizes two or more of the listed traits. Also in some embodiments profiles further comprise data and characteristics derived from other than the rating process, including customer interaction history, and agent skills. In still other embodiments there may be a step for publishing agent profiles in human-readable form. And in some embodiments customers are provided with incentives to rate an agent.

### BRIEF DESCRIPTION OF THE DRAWING FIGURES

FIG. 1 is an architectural overview of a communications network that supports agent to customer compatibility routing according to an embodiment of the present invention.

FIG. 2 is a process flow chart illustrating steps for creating and managing profile data for agents and customers for use in agent compatibility routing.

FIG. 3 is a plan view of an interactive electronic form for rating an agent.

FIG. 4 is a logical diagram illustrating processing of input data to generate agent and customer profile values.

FIG. 5 is a process flow chart illustrating steps for routing customers to agents according to agent compatibility.

### DETAILED DESCRIPTION

The inventors provide a system for establishing a measure of compatibility between certain repeat business customers and agents working within a call center environment, and methods for use thereof in routing of interactions. The present invention will be described in enabling detail using the following examples, which may describe more than one relevant embodiment falling within the scope of the present invention.

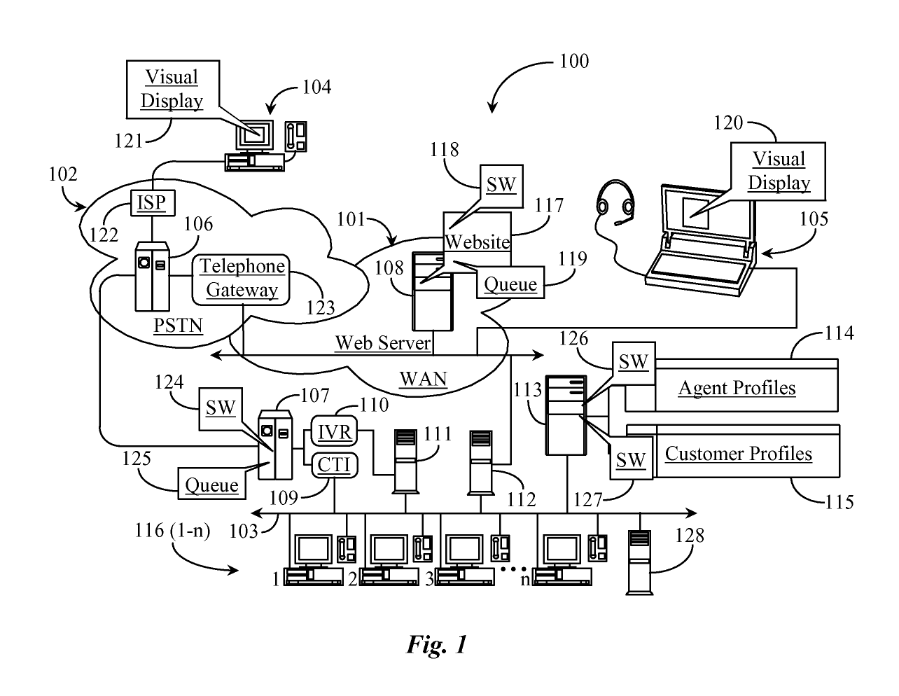

FIG. 1 is an architectural overview of a communications network 100 that supports customer/agent compatibility routing according to an embodiment of the present invention. Communications network 100 includes a wide-area-network (WAN) 101. WAN 101 is the Internet network in a preferred embodiment because of a high public access characteristic. In one embodiment WAN 101 may be a private or corporate WAN without departing from the spirit and scope of the present invention. WAN 101 may be referred to throughout this specification as Internet 101. Internet 101 includes a network backbone 129 representing all of the lines, equipment, and access points that make up the Internet network as a whole including any sub-networks. Therefore, there are no geographic limitations to the practice of the present invention.

Internet 101 includes a Web server 108 connected to network backbone 129. Web server 108 is adapted with a digital medium and software to function as an Internet server capable of hosting one or more Websites such as a Website 117 logically drawn and associated with the server as its hosting server. Website 117 may be created using hypertext markup language (HTML), a version of HTML, or another Web page markup language. Web server 108 may be maintained by a Web-hosting service company or by an enterprise that creates and maintains its own Website data. A third-party Web-services hosting company most probably maintains server 108.

Website 117 serves as a commercial customer access point meaning the Website is dedicated to sales and service for customers of the associated business or businesses. Website 117 includes a virtual queue point for customers that have requested live assistance through the Website. Virtual queue 119 may be a virtual waiting room (known to the inventor) that is a Web page on which the customer might perform one or more interactions with a presentation in which interaction via computing input is possible while the customer waits for a live agent on the same device or using a telephone. Queue 119 is virtual in the sense that it is part (page) of the Website presented to customers who are connected to the Website and who have initiated a request for live assistance by interacting with a contact channel also available on Website 117. Queue 119 is a workspace container within which an interactive presentation may be served and interacted with by the customer. Website 117 includes software adapted to serve an interactive presentation to customers that are connected to the Website via a computing appliance including but not limited to a computer, a Laptop, a personal digital assistant (PDA), a smart phone, or a cellular telephone with Internet browsing capability. In one embodiment the virtual queue and presentation service may be described using Web service description language (WSDL), which is a markup for designing Web services.

PSTN 102 has connection to network backbone 129 by way of a telephony gateway 123 connected to network backbone 129 and to a network telephone switch 106. Telephone gateway 123 represents and network gateway that can bridge communication over the disparate networks. Network telephone switch 106 may be a private branch exchange switch, an automated call distributing (ACD) switch, or some other type of telephone switch including a soft switch or software switch without departing from the spirit and scope of the present invention.

A customer station 104 is illustrated in this example and represents any customer accessing Website 117 through an Internet service provider. Customer station 104 has connection to an Internet Service Provider (ISP) 122 for assistance in connecting to the Internet network. Customer station 104 comprises a computing appliance and a telephone. A second customer station 105 is illustrated in this example. Customer station 105 comprises a Laptop computer and a telephony headset. Customer station 105 is illustrated directly connected to network backbone 129. Customer station 105 may also connect to Website 117 through an ISP and a carrier network.

Customers who access Website 117 are handled by a call center represented herein by a LAN network 103 supporting a variety of call center equipment. A plurality of agent workstations 116 (1-n) is provided and supported by LAN 103. Each workstation 116 (1-n) includes a personnel computer (PC) and a telephone. In this example, the computer and telephone in each agent station 116 (1-n) are connected directly to LAN 103. In one embodiment the telephones in agent workstations 116 (1-n) are plain old telephony service (POTS) phones that are connected to a central telephone switch. In another embodiment they are private branch exchange handsets connected directly to LAN. Customers who access Website 117 and elect live services are treated by one of a pool of agents associated with the multiple agents shown in this example.

LAN 103 supports an Internet router 112. Internet router 112 represents any router or hub used to enable LAN 103 to be connected online to Internet network 101. Customers visiting Website 117 may communicate electronically with agents operating agent stations 116 (1-n) through router 112. LAN 103 supports a telephone switch 107. Switch 107 is enhanced in this example for computer telephony integration (CTI) with a CTI processor 109 connected directly to LAN 103 and to switch 107. CTI processor 109 provides routing and other switching intelligence to telephone switch 107. Telephone switch 107 may be a PBX or an ACD as described further above with respect to switch 106. Telephone switch 107 includes a queue 125 for queuing callers at the ahead of agent level routing. Callers from the PSTN may call into the call center and may be queued for live assistance at queue 125.

Switch 107 is also enhanced for interactive voice response (IVR) capability sing an IVR system 110 connected to switch 107. Software 124 represents an audible interactive presentation made to customers via IVR 110. IVR 110 has connected to a voice application server 111. Voice application server 111 is adapted with a digital medium and the appropriate software to provide interactive voice applications for interfacing with the customers that have been routed to switch 107 for self-assisted or live interaction.

LAN 103 supports a statistics server 128. Statistics server 128 is adapted with a digital medium and the appropriate software to serve call-center statistics upon request by any call-center automated system or authorized human operator. LAN 103 also supports a universal routing server 113. Universal routing sever 113 is adapted with a digital medium and the appropriate software to provide routing instructions for routing interactions over LAN 103 to available agents operating agent stations 116 (1-n).

In this example, universal routing server 113 is connected to a data repository 114 adapted to store profile data referred to herein as agent profiles created from agent-rating activities from customers after having live interactions with those agents and from information known about individual agents associated with the call-center. Server 113 is also connected to a data repository 115 adapted to store profile data referred to herein as customer profiles created from information known about individual customers and from psychological inferences about those customers made through analysis of agent-rating activities performed by those customers after having live interaction with agents.

In this example, software 126 installed on server 113 provides data analysis of agent-rating activities and other data to generate both agent profiles and customer profiles that may later be compared in a routing process to route customers to agents within the call center. Agent and customer profiles may be represented as numerical or empirical values that can be used in a matching process performed to find a best fit agent for a particular customer based on compatibility inferred by the profile information stored for the customer and the agent.

For example, when a customer such as one operating from station 105 arrives on Website 117 and requests live assistance, the request for live assistance is routed as a pending interaction from the Website into the call center. In this case the request must be serviced by a live agent for any rating activity to take place. Live assistance is characterized as a voice call in this example, however the invention may also be practiced in a text or email environment without departing from the spirit and scope of the present invention.

When the customer is physically on hold waiting for an agent, the call center system uses voice prompting in this example to solicit the customer to rate the agent that the customer will be routed to. The solicitation may be accomplished through IVR or through text messaging. If the solicitation is a voice prompt then the customer need not be physically connected to the Website. If the solicitation is a text prompt made through the Website, then connection to the site is, of course, required.

If a customer agrees to rate the agent that they will be routed to the customer is routed to the next available agent. It may be that the customer has been rated before and or that the agent has been rated before. In this case the customer may be routed to an agent based on compatibility between aspects of the agent and customer's profile. It is also possible that the customer and or agent has not been rated before meaning that initial profiles are generated and are subject to further updates that may occur with subsequent rating activity of those same agents by repeat and new customers. Likewise, customer profiles may be updated based on further agent-rating activity.

After finishing the transaction, the agent drops out of the connection and the customer may be served an agent-rating interactive presentation. Such a presentation may be a visual one that is logically represented in this example as a visual display 120 appearing on customer station 105, or a visual display 121 appearing on customer station 104. The visual displays 120 and 121 may include both representation of a virtual queue, and an interactive presentation served within the queue window. The customer may then interact with the display to perform a task such as rating the agent. It is noted herein that the visual display containing a rating form or the like for interaction is served from Website 117 with the aid of software 118. In one embodiment is may be served during the voice portion of the call. In another embodiment the system waits until the transaction is complete before serving the interactive application or form.

Once the customer has interacted with the agent and has formed an opinion about the agent, the customer is presented with a few to several statements about the agent. The customer may elect a pre-prepared response to each of the questions. The responses may be along the lines of agreement statement such as strongly agree, reluctantly agree, and strongly disagree. In one embodiment the customer interacts with one or more graphics rather than responding to one or more interactive questions. Other interactive activities the customer might perform in agent rating include prioritizing a list of pre-assembled agent traits. The customer input is analyzed by the system with the aid of software 126 to provide that customers feelings about that agent (agent rating) and to provide some psychological information about the customer (inferred characteristics). The system may also take into account previous profile values and information that is pre-known about agents and customers if available.

If an agent is new to the call center and just starting handling interactions, then the first customer rating of that agent culminates in the agent's profile. As more customers rate the agent, the profile value or score may be updated and the agent's profile score or value may change over time. Similarly, if the customer is new to the system (first time caller), the inference made about the customer as a result of rating activity of the agent culminates in that customer's profile. As the customer performs more agent ratings, the psychological inferences about the customer collected at each subsequent rating may cause the customer's profile value or score to change over time. Demographic data, purchasing history, monitored calls, chat records, and other data may also be used to help generate a customer profile. Likewise, demographic data, interaction history, monitored calls, chat records, and performance data might be used to help generate an agent profile.

It is noted herein that the customer profile information is inferred by the system with no active customer ratings or evaluations being performed by agents or other personnel. In this way there is no overhead incurred in the generation of a customer profile. The customers, based on willingness, perform the task of agent rating. Therefore, a customer might be persuaded to perform an agent rating through advancement in queue, product or service discount, purchasing point, or some other incentive. The profiles of agents and customers may be represented by numerical values or scores that could be incorporated in a routing process that seeks to route a customer with a specific score to an agent with a like score. In a preferred embodiment the closes matching scores between agents and customers represent a psychological compatibility or synergy between the agent and customer. In this way, customers might feel more comfortable with certain call center agents and may develop more loyalty to the business, which may boost the overall success rate of transactions performed.

In one embodiment, agent profiles are based both on compatibility points (rated by customer) and actual agent performance and skills ratings (rated by the call-center statistics system). In this embodiment, agent profiles in long human-readable form, may be published to customers that are, for example, in the virtual waiting room queue. The information may also provide a statistic of how many agents in the system are rated and how many of those agents are on duty. When a customer is routed to a highly rated agent, this fact could be communicated to them at the time of routing the call or interaction request. A statement might be verbalized through IVR or other method that states the customer is being routed to one of the highest rated customer service reps.

In one embodiment where agent ratings are published to customers, the agents may be independent agent competing for customers such as, for example independent certified tax advisors may compete through a Web portal or site like Website 117. These agents may be explicitly rated with the ratings published. The amount of their allowable service rate may be based upon the rating. In this case a customer in a virtual waiting room, for example, may see this published information along with agent availability information and may actually pick their agent or may ask to be routed to one with a specific published rating. That agent might be busy in which case the customer would wait for the agent to become available. In one embodiment customers may also rate service departments in addition to individual agents. Statistics may also be used to help rate service departments.

In another embodiment customer profiles are made public to agents working the center. In this case agents may review the profile of a customer shortly before receiving the call to help the agent better prepare for that particular customer type. For example, a customer that has a combative component in his profile would be flagged and routed to an agent who has more experience talking the customer down from an agitated state. The ratings or profiles if published would be human readable and reviewable and may not resemble the routing score or value of the profiles used in matching customers to most compatible agents.

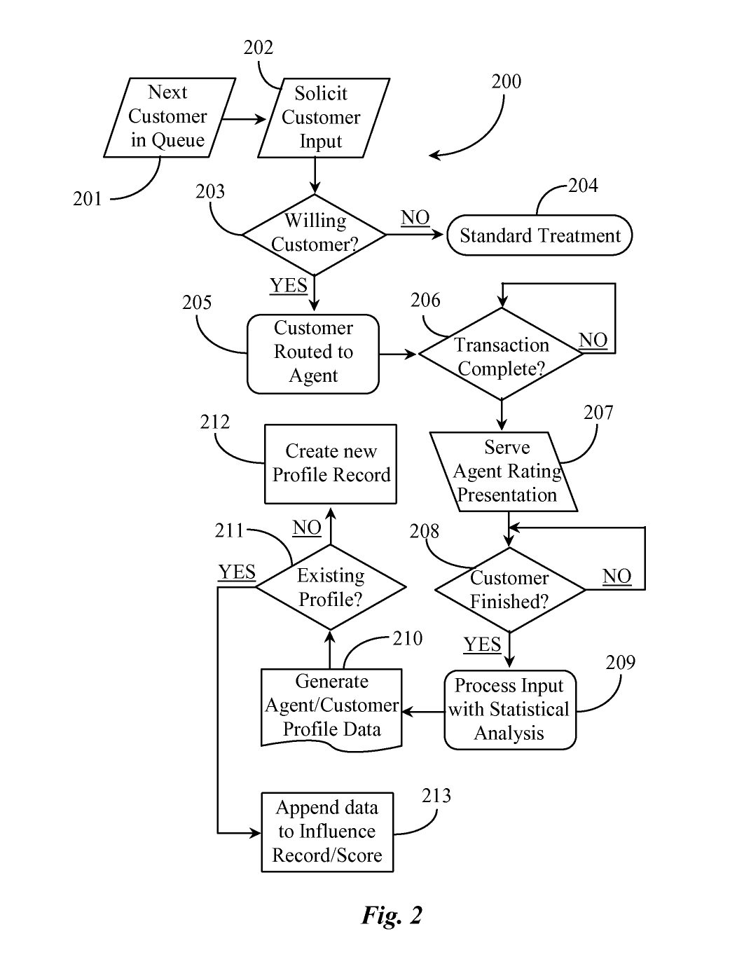

FIG. 2 is a process flow chart 200 illustrating steps for creating and managing profile data for agents and customers for use in agent compatibility routing. At step 201, the call center system accepts the next caller waiting in queue for processing. At step 202 the system solicits the customer to rate an agent. The solicitation can be made a number of ways. For example, if the customer is calling into the call center and is not connected to the companies Website, then the customer may be solicited by traditional IVR treatment. If the customer is connected to the Website and has requested live assistance and has voice communication capability on the device used to connect to the Website, then solicitation might be a digital IVR prompt once the customer launches a call through the Website. An interactive visual text prompt might be received at the customer device if the live assistance will be text based, such as a one on one chat with an agent, for example.

At step 203, the system determines if the customer is willing to rate an agent. In one embodiment some incentive may be used to persuade a customer to rate an agent. For example, a customer may take advantage of a prioritized position in queue in exchange for willingness to rate an agent. Other incentives may also be offered instead such as a discount on products or services in exchange for agreeing to rate an agent.

At step 203, if the customer declines the offer to rate an agent then at step 204 the customer may receive whatever standard treatment is available such as a normal call routing to an agent when an agent becomes available. In one embodiment customers who continually refuse to participate in agent rating may be categorized with a particular psychological trait that may still be used to help derive a psychological profile or a profile with a significant psychological component that can be leveraged in agent compatibility routing. If the customer is willing to rate an agent at step 203, then at step 205 that customer is routed to an agent when one becomes available. It may be that a customer who is willing to rate an agent is prioritized in queue over a customer who is not willing to rate an agent.

Assuming that the customer is willing to rate an agent in step 203 and is routed to an agent in step 205, the system will monitor the transaction to determine when the transaction between the customer and agent is completed at step 206. If the system determines the transaction is not completed then the system waits. If the system determines that the transaction has completed at step 206, an interactive presentation adapted to assist the customer in rating an agent is served or otherwise presented to the customer. At step 208 the system monitors the customer interaction with the presentation served to determine when the customer is finished rating the agent. As described above, the agent-rating presentation may be a visual presentation with selectable options. In one embodiment the agent-rating presentation is audio only.

At step 208 the system determines if the customer is finished rating the agent. If the customer is not finished at step 208 the process waits until it can be determined that the customer is finished rating the agent. In one embodiment the rating presentation is an interactive electronic form containing a few to several pre-loaded statements or questions having two or more response choices for the customer to select relative to each statement or question in the form. Additionally, the customer may be asked to select two or more top agent traits that would be important to the customer from a larger list of typical traits. In this way, the agent is rated literally by the customer and the customer is rated by system inference of one or more psychological traits attributable to the customer based on how the customer performed the agent rating. In a preferred embodiment the rating activity occurs just after the transaction with a customer and agent to be rated is complete.

After the customer has submitted the rating information, the input from that customer is processed along with any additional data from historical or statistics databases that might be helpful in rating. For example, data about the agent already known to the call center can be used to supplement the rating activity data submitted through the interactive form for that agent. Moreover, data about the customer that is already known to the system may be leveraged as well to help the system generate a customer profile from analysis of the rating activity and from analysis of pre-known data about that customer.

At step 210, the system generates both agent profile data and customer profile data termed agent and customer profiles in this specification. Later these profiles are leveraged in agent compatibility routing where customers are routed according to best-fit psychological profile value or score. Each time an agent is rated, the system determines at step 211 if the customer and if the agent already had existing profiles.

If, for example, the system determined at step 211 that the agent already had an existing profile created through rating activity by customers, then at step 213 the existing profile for that agent may be updated with the most recent rating data. In this case, the new data might affect the current rating value or score attributed to the agent profile or it may not. The value or score of an agent profile can be derived using any one of a number of techniques including establishing values for responses to individual rating statements or questions received from the customer.

If, for example, the system determined at step 211 that a customer already had an existing profile inferred by the system as a result of analyzing previous rating activities of agents performed by that customer, then at step 213 the existing profile for that customer may be updated with the most recent rating data. In this case, the new data might affect the current rating value or score attributed to the customer profile or it may not. The value or score of a customer profile can be derived by attributing a value to a customer response in rating an agent where that response is analyzed in part using a rules base that draws correlations between submitted rating results and tendencies toward specific psychological traits for that customer, which may be positive traits or negative traits or a mixture of both. In both aspects, additional data that may already be known about the transaction parties can be considered in the generation of profile value or score.

If for an agent or for a customer, it is determined at step 211 that a profile does not exist for that agent or customer, then a new profile is created at step 213 for that agent or customer. The new profile for an agent or for a customer will be refined over time as that agent is rated or that customer engages in rating activities. The ultimate goal of performing the rating activity and subsequent analysis of the results is to reveal compatibility points between certain agent profiles and certain customer profiles that might be exploited to increase the loyalty and well being of the customer in order to enhance the likelihood of overall success in attaining call center goals such as increasing revenue and developing more loyal customers. A rules base may be created and used during data analysis to help define what the results mean for both agents and customers.

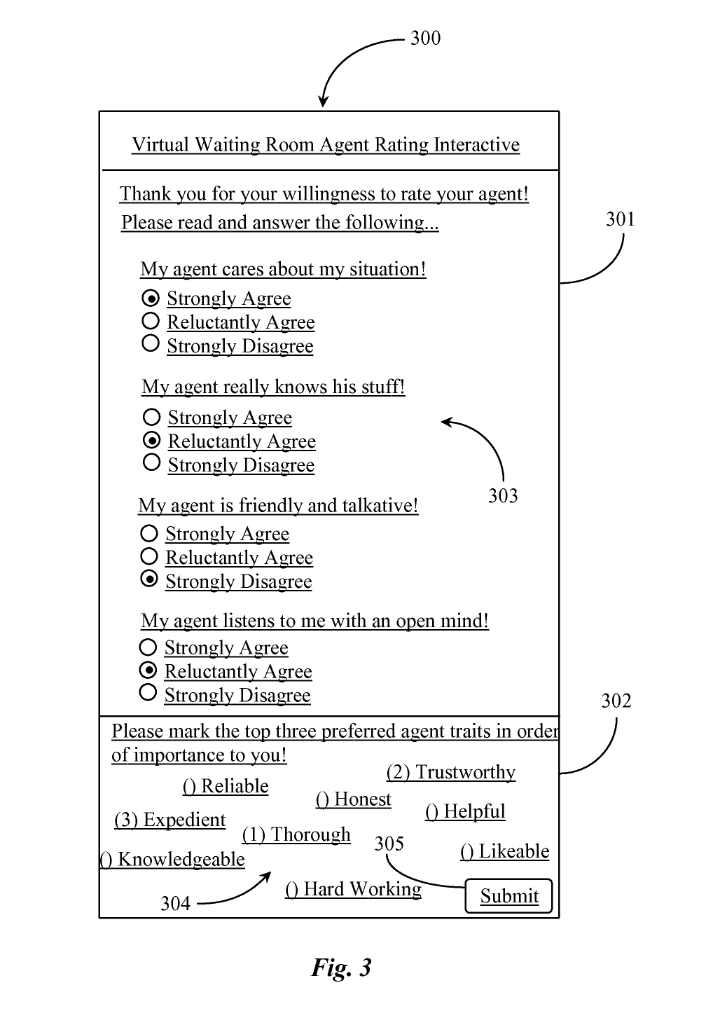

FIG. 3 is a plan view of an interactive electronic form 300 for rating an agent. Electronic form 300 represents an example of an interactive agent-rating presentation that might be sent to a customer that was successfully solicited to rate an agent. Form 300 includes a first section 301 that includes one or more statements or questions 303 for the customer to respond to. In this example there are four rather general statements 303 that characterize one or more agent traits that the customer is asked to strongly agree with, reluctantly agree with, or strongly disagree with. The top of section 301 may include a thank you statement for the customer's willingness to rate the agent.

Form 300 includes a second section 302 that includes a number of possible agent traits 304 listed in no particular order in the workspace provided. In the second section 302, the customer is asked to list the top three of the visible agent traits that are most important to the customer for the agent working with that customer to posses. In this example there are 9 possible agent traits to choose from. In this example the customer marks the top three by entering a 1 in the brackets next to the top trait, a 2 in the brackets next to the second most important trait, and a 3 in the brackets next to the least important of the three chosen traits. When the customer is finished with the form, the customer may submit the form to the call center by activating a submission button 305 provided for the purpose.

The form is then analyzed against a set of rules to determine both agent profile information and customer profile information. The both data sets are determined by analysis of the responses the customer has chosen against a set of rules and both sets of data may be further enhanced or qualified by taking into account information already known by the system about the agent and customer in the transaction. If neither the agent nor the customer has been profiled before the current transaction, then the data submitted with the first rating activity will provide initial profiles of both the agent and the customer. Any party to the transaction that already has an existing profile may see that profile appended with the latest rating activity data. Such updating may result in a change to the value or score of an existing profile over time.

In a preferred embodiment of the present invention, each profile generated is a psychological profile or at least has a psychological component included in the profile data that may be leveraged during routing of future requests from profiled customers to help match that customer to an available agent that will be “most psychologically” compatible to that particular customer from a pool of available agents. In this regard, the questions or statements used to evaluate or rate the agent are psychologically loaded statements or questions whereby the responses tend to predict or suggest possible or probable psychological traits possessed by the customer. Repeated rating activity over time helps to fine tune the compatibility points that might exist between agents and customers transacting business through the call center environment.

In one embodiment of the present invention, form 300 includes more than two sections that may be interactive or it may only contain one interactive section. In one embodiment another response option might be “I don't care”. In this example, the traits described in statements 303 of section 301 cover the agent's level of caring about the customer; the agent's level of knowledge about the business; the agent's level of personability; and the agent's level of open mindedness all from the perspective of the particular customer rating the agent. Values may be attributed for each statement depending on the analyzed response to the statement and values may also be attributed to the customer based on the way these statements were answered.

In the second section, the customer tells something about him or herself by listing or admitting to the three top most important traits that that customer desires in an agent they are transacting with. This insight is used to infer some psychological traits that can be attributed to that customer. In one embodiment, electronic form 300 might have one or more exercises that involved selection of or manipulation of graphics instead of or in conjunction with responding to statements or questions. In a preferred embodiment the activity is designed according to well-known psychological evaluation models where certain responses to certain activities or statements mean certain things in those psychological evaluation models. All of the agents working at the center will have been rated many times by many different customers in a short amount of time. The rating activity of the agents is performed in a manner that does not interfere with their operations so it has no effect on call flow. Likewise the system rates the customers in the background passively, so no call-center agents or any personnel of the contact center are involved in customer rating or profiling.

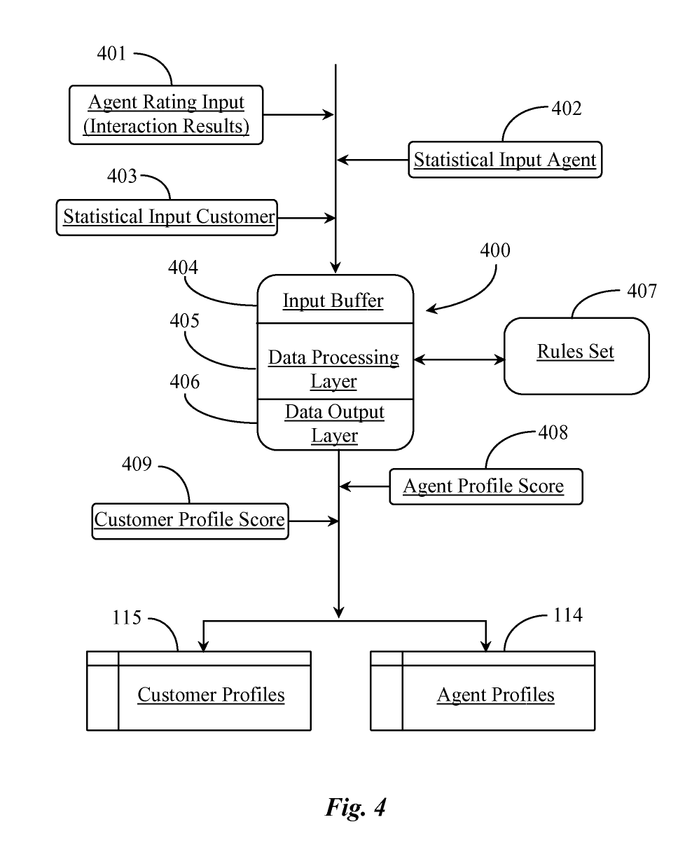

FIG. 4 is a logical diagram illustrating processing of input data via software 400 to generate agent and customer profile values. Software 400 may be analogous to software 126 described with reference to FIG. 1, or it may be an additional module dedicated for analyzing agent-rating data and generating profile data for both agents and customers. Module 400 includes a data input buffer 404 adapted to store all of the data that will be input into the module from a single agent-rating session involving one agent and one customer. Input into module 400 includes agent-rating input 401, which are the interaction results of the customer's agent-rating activity.

In one embodiment, the data input into module 400 further includes statistical input 402 about the agent that is known by the system. This input may include current rating data from a previous rating update. The input may also include performance statistics and other information already known about the agent that might be useful in performance of an analysis lending to an agent profile with at least one significant psychological component. In one embodiment the data input into module 400 further includes statistical input 403 about the customer involved in the rating activity. This input may also include previous psychological rating data, demographic information, previous recorded call data results, and any other data that might be useful in generating a profile of the customer that includes at least one significant psychological component.

Module 400 includes a data processing layer 405 that is adapted to process the input data against a set of rules 407 to determine profile data. Module 400 has a data output layer that outputs from the module an agent profile score or value 408 and a customer profile score or value 409. The agent profile score or value 408 may be multi-faceted meaning that there may be two or more value components covering differing aspects of the overall profile. The customer profile score or value 409 may also be multi-faceted. Agent profile data is stored in repository 114 for later use and customer profile data is stored in repository 115.

In one embodiment both data sets may be stored in a same repository. The information is used post generation to help route customers to agents who are deemed most compatible psychologically to that customer. In a preferred embodiment psychological compatibility as defined in this specification refers to characteristics or traits possessed by an agent that tend to lead to more successful outcomes when dealing with specific customers having a specific psychological profile or profile component that stands out. For routing purposes, a single point value or score from a scale or range might be attributed to both agents and customers where matching scores or values during routing indicates some level of compatibility between the agent and the customer. In one embodiment, an agent that possesses a lower score or value might best serve a customer that has a high score or value. In another embodiment if the score is the same, it is a best match (customer to agent).

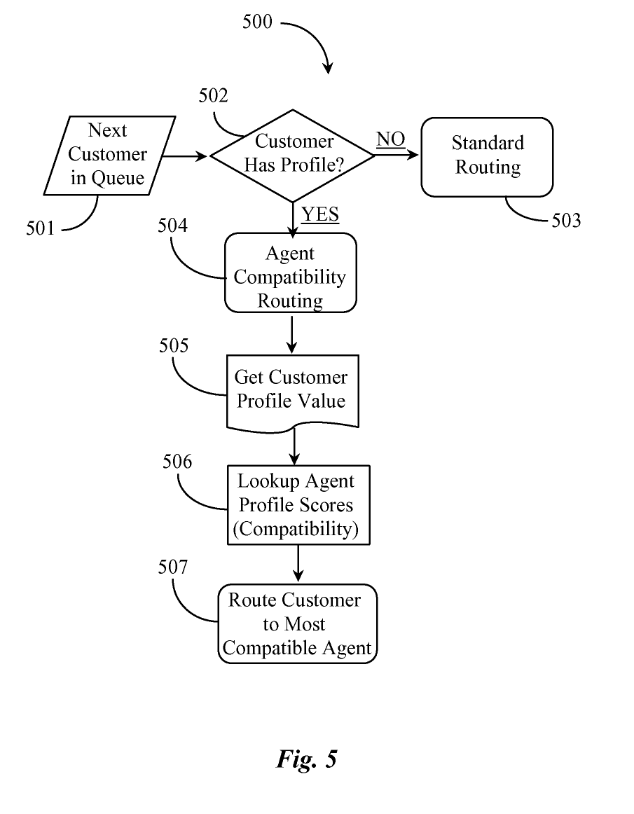

FIG. 5 is a process flow chart 500 illustrating steps for routing customers to agents according to agent compatibility. In this example the routing system uses the agent and customer profile scores or values to create a best compatibility fit between a given customer and an available agent. At step 501 the routing system takes the nest customer in queue for routing. At step 502 the system determines if the customer has a customer profile inferred by the system during past agent-rating activities pursued by the customer. If at step 502 the system determines that the customer does not yet have a profile, the process may revert to a standard routing modality for that particular customer. Moreover, that particular customer would be solicited to rate an agent thereby being afforded a customer profile for use in future routing should that particular customer request live assistance in the future.

If the system determines the customer has a customer profile at step 502, the process moves to step 504 where the agent compatibility routing modality is selected for routing the interaction. At step 505 the routing system gets the customer profile value or score from the customer profile database. At step 506 the routing system performs a lookup of agent profile values or scores of the agents who are, at the time of the lookup operation, available in the agent pool working the queue and identifies an available agent having a value or score that most closely matches the value or score of the customer profile. In one embodiment the system may take into consideration values or scores of agents who are predicted to be available to answer calls shortly.

At step 507, the customer is routed to the most compatible agent of the pool of available agents based at least in part on psychological compatibility indicated by matching profile values/scores of the customer to the available agents. In one embodiment if two or more agents have the same value or score as a customer, then any of those agents may be selected to accept the pending interaction. In another embodiment another component based on agent performance is used to break a tie based on compatibility points. So where two or more agents are equally compatible with the customer from a psychological standpoint, the most skilled agent of those equally compatible agents may be the agent selected to accept the interaction.

In one embodiment of the present invention, both routing modalities “standard” and “agent compatibility” are practiced on the same queue or queues where customers without a profile and customers with a profile are routed with the profiled customers gaining some preference in queue such as moving to the front of the queue, etc. In another embodiment there is no priority for order in queue and all customers are routed on a first come first served basis and agent compatibility routing comes into play whenever there is more than one available agent. In one embodiment, customers having profiles are segregated into another queue handled by a different group of agents. There are many possible scenarios.

It will be apparent to one with skill in the art that the profiling and routing system of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A method for routing transactions from customers to agents, comprising the steps of:
(a) upon receiving, at a routing server, a transaction to route, soliciting the customers before connection to an agent, to rate the agents after agent interaction, and checking for existing customer routing profiles;
(b) upon finding an existing routing profile for a customer, checking for existing routing profiles of available agents, and finding existing agent routing profiles, routing customer to agent by matching routing profiles;
(c) if no existing routing profile is found for a customer, routing to an agent by a default routing strategy;
(d) tracking routing and agent interaction, and presenting to the customers, by software executing from a non-transitory medium, and after the interactions, an interactive rating interface;
(e) rating the agents by the customers using the interactive interface;
(f) updating agent profiles with rating results of customer ratings, and in the event of no available profile, creating a new profile for the agents with the rating results; and
(g) discerning characteristics of rating customers by the ratings of agents by the customers, updating customer profiles with the characteristics, and in the event of no available customer profile, creating a new customer profile with the characteristics.

2. The method of claim 1 wherein, in step (e) the interactive interface is an audible presentation delivered to a customer by an interactive voice response unit.

3. The method of claim 1 wherein, in step (e) the interactive interface is a displayed interactive form.

4. The method of claim 1 wherein, in step (e) the interactive interface includes one or more interactive questions with preprogrammed selectable responses.

5. The method of claim 1 wherein, in step (e) the interactive interface includes one or more interactive graphics.

6. The method of claim 1 wherein, in step (e) the interface includes a pre-assembled list of agent traits whereby the customer prioritizes two or more of the listed traits.

7. The method of claim 1 wherein agent and customer profiles further comprise data and characteristics derived from other than the rating process, including customer interaction history, and agent skills.

8. The method of claim 1 including a step for publishing agent profiles in human-readable form.

9. The method of claim 1 wherein the customers are provided with incentives to rate an agent.

10. A system for routing transactions from customers to agents, comprising:
a routing server receiving transactions to route;
a data repository storing routing profiles for customers and agents; and
routing software executing on the routing server from a non-transitory machine readable medium, the routing software providing:
a function soliciting customers before connection to an agent to rate the agents after agent interaction;
a function checking for existing customer routing profile, and upon finding an existing routing profile for a customer, checking for existing routing profiles of available agents, and finding existing agent routing profiles, routing customer to agent by matching routing profiles, and finding no profile for the customer, routing to an agent by a default routing strategy;
a function tracking routing and agent interaction, and presenting to the customers, by software executing from a non-transitory medium, and after the interactions, an interactive rating interface;
a function rating the agents by the customers using the interactive interface;
a function updating agent profiles with rating results of customer ratings, and in the event of no available profile, creating a new profile for the agents with the rating results; and
a function discerning characteristics of rating customers by the ratings of agents by the customers, updating customer profiles with the characteristics, and in the event of no available customer profile, creating a new customer profile with the characteristics.

11. The system of claim 10 wherein the interactive interface is an audible presentation delivered to a customer by an interactive voice response unit.

12. The system of claim 10 wherein the interactive interface is a displayed interactive form.

13. The system of claim 10 wherein the interactive interface includes one or more interactive questions with preprogrammed selectable responses.

14. The system of claim 10 wherein the interactive interface includes one or more interactive graphics.

15. The system of claim 10 wherein the interface includes a pre-assembled list of agent traits whereby the customer prioritizes two or more of the listed traits.

16. The system of claim 10 wherein agent and customer profiles further comprise data and characteristics derived from other than the rating process, including customer interaction history, and agent skills.

17. The system of claim 10 including a function publishing agent profiles in human-readable form.

18. The system of claim 10 wherein the customers are provided with incentives to rate an agent.
